(19) United States
(12) Patent Application Publication
(10) Pub. No.: US 2010/0294221 A1
(43) Pub. Date: Nov. 25, 2010

(54) SET CONTAINING AN ELECTROMAGNET AND AN ELECTROMAGNETIC PALETTE, AND VALVE ACTUATOR COMPRISING SUCH A SET

(75) Inventors: Emmanuel Talon, Verneuil-sur-Seine (FR); Severin Viennot, Courbevoie (FR); Manuela Mateos-Bugatti, Osny (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES DE CONTROLE MOTEUR, Cergy Pontoise Cedex (FR)

(21) Appl. No.: 12/809,883

(22) PCT Filed: Dec. 15, 2008
(86) PCT No.: PCT/FR08/01738

§ 371 Date: Aug. 2, 2010

(30) Foreign Application Priority Data
Dec. 20, 2007 (FR) 07/08940

(51) Int. Cl. F01L 9/04; H01F 7/13

(52) U.S. Cl. 123/90.11; 335/279

(57) ABSTRACT

The invention relates to a set containing an electromagnet (14) and an electromagnet palette that can be magnetically linked to the electromagnet (14), the palette comprising a connecting edge arranged in such a way as to connect to a connecting limb (141D, 141G) formed in the electromagnet (14). The connection between the connecting edge of the palette and the connecting limb (14 ID, 141G) of the electromagnet (14) is asymmetrical in such a way as to encourage the palette to pivot in a pre-determined direction during the interruption of the magnetic connection.

Set containing an electromagnet and an electromagnetic palette, and valve actuator comprising such a set

The invention relates to a set containing an electromagnetic and an electromagnet armature palette and to a valve actuator equipped with such a set.

The invention of the present application has been born out of a problem with controlling the valves of the cylinders of internal combustion engines that do not have cam shafts, more specifically, using what is known as an electromagnetic cam shaft, also termed “camless” technology.

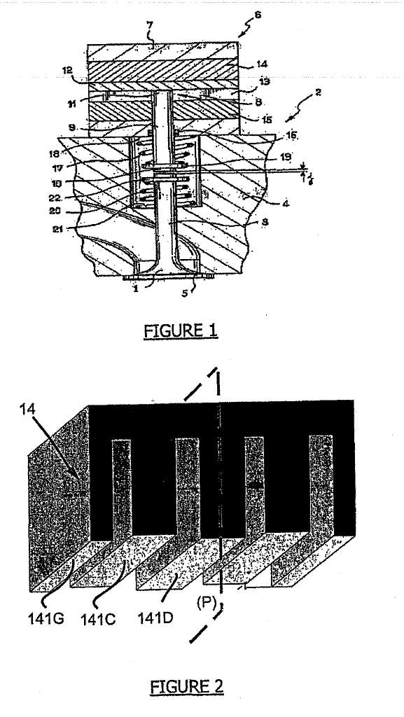

With reference to FIG. 1, a valve 1, whether this is the inlet or the exhaust valve, is returned to its seat 5 by a valve spring 20 mounted around a valve stem 3 and, under the action of an electromagnet armature palette 12 made of magnetic material, of an armature palette spring 17 and of an opening electromagnet 15, the valve 1 is moved off its seat 5 by an armature palette stem 9 pushing against the valve stem 3. The opening electromagnet 15 is generally associated with a closing electromagnet 14, the armature palette 12 being mounted between the two electromagnets 14, 15.

When the closing electromagnet 14 is activated, the valve spring 20 drives the armature palette 12 which comes into contact with part of the magnetic circuit of this electromagnet 14, the closing electromagnet 14 guiding the armature palette 12 at the end of its travel. This movement causes the stems 3 and 9 to slide such that the head of the valve 1 is moved until it rests on its seat 5. The valve 1 is then closed.

When the opening electromagnet 15 is activated, the armature palette spring 17 drives the armature palette 12 which comes into contact with part of the magnetic circuit of this second electromagnet, the opening electromagnet 15 guiding the armature palette 12 at the end of its travel. The movement of the armature palette drives the stems 3 and 9, the head of the valve 1 therefore moving away from its seat. The valve 1 is then in the open position.

When neither of the two electromagnets 14, 15 is activated, the armature palette 12 is held between the two of them by the valve spring 20 and the armature palette spring 17 mounted around its stem 9.

The springs 17 and 20 are associated with the movement of the stems 9 and 3, becoming compressed or expanded according to the movements of these stems, a resonant electromagnetic system thus being formed.

The valve 1 and the armature palette 12 thus alternate fixed positions, known as switched positions, with transient movements between these two positions.

With reference to FIG. 3, an electromagnet 14(15) conventionally comprises laminations bundled together with permanent magnets 18 and a coil 20, such an electromagnet 14 being able to generate high-amplitude magnetic forces to move the armature palette 12 between its switched positions. In order to protect the magnets upon contact with the armature palette 12, the electromagnet 14 is machined so that the magnets 18 are set back from the regions that butt against the armature palette 12. In particular, with reference to FIGS. 2 and 3, legs 141G, 141C, 141D are machined in the body of the electromagnet 14 to protect the magnets 18, the central leg 141C being set back with respect to the lateral legs 141G, 141D.

Again with reference to FIG. 2, the electromagnet 14 may simultaneously control two electromagnet armature palettes 12 attaching respectively to the electromagnet legs positioned on the two sides of the plane (P).

With reference to FIG. 3, when the armature palette 12 moves from a closed position to an open position it “detaches” from the closing electromagnet 14 to become attached to the opening electromagnet 15. It has been found that, in this movement, one lateral edge 121G, 121D of the armature palette 12 becomes detached more quickly than the other.

Again with reference to FIG. 3, by way of example, as the armature palette 12 detaches from the electromagnet 14, the magnetic force exerted by the electromagnet 14 decreases, the left-hand edge of the left-hand lateral leg 141G of the electromagnet 14 in this example exerting greater magnetic attraction than its right-hand edge, thus causing the armature vane 12 to tilt as it falls whereas its stem 9 is, for its part, axially guided in its movement by a guide way 10. This causes an angle of tilt a between the armature palette 12 and its stem 9.

The tilting of the armature palette 12 follows various statistical laws and cannot be predicted with certainty, it being equally possible for the left-hand edge 121G of the armature palette 12 to detach before the right-hand edge 121D. Further, this tilting occurs as much when the armature palette attaches itself to as when it detaches itself from an electromagnet. The random tiltings of the armature palette 12, both on closing and on opening, give rise to difficulties in establishing control laws to control engine valve operation.

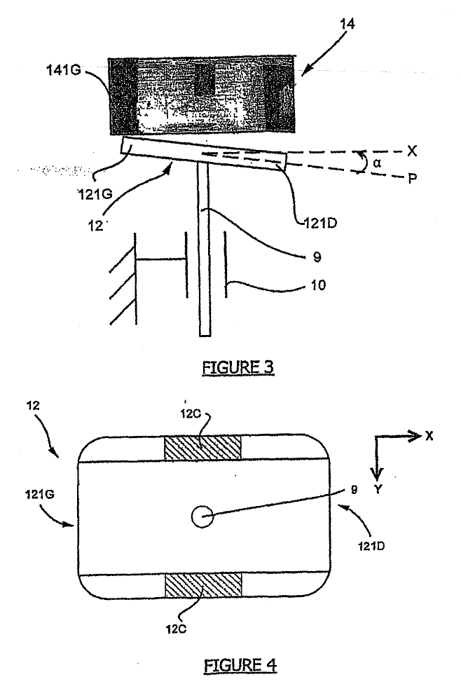

To solve this problem, with reference to FIG. 4, it is known practice for the magnetized zone 12C of the armature palette 12 to be confined to the axial part near the stem 9 so as to limit the magnitude of the angle of tilt a between the stem 9 and its armature palette 12. In spite of this modification, it is not possible to predict how the armature palette 12 will detach itself from the electromagnet 14.

The random nature of the attachment/detachment of the armature palette 12 with respect to the electromagnets 14, 15 remains a major disadvantage, preventing full benefit from being derived from the ability to exert individual control over the valves of an engine fitted with a camless device.

For this reason, the invention relates to a set containing an electromagnet and an electromagnet armature palette designed to attach magnetically to said electromagnet, the armature palette comprising an attachment edge designed to attach to an attachment leg formed in the electromagnet, the set being characterized in that the attachment between said attachment edge of the armature palette and said attachment leg of the electromagnet is asymmetric so as to encourage the armature palette to tilt in a predetermined direction when the magnetic attachment is broken.

The asymmetry in the magnetic attachment between the armature palette and the electromagnet forces the armature palette to tilt in a predetermined direction, the tiltings of the armature palette as it attaches to/detaches from the electromagnet no longer being random.

The invention will find particular applications in sets in which the electromagnet comprises a core of E-shaped cross section, said attachment leg or legs contributing to the asymmetric attachment to the armature palette being one and/or other of the outer legs of the E. In the case of a set intended for controlling two valves, this may be a double E.

According to one first embodiment of the invention, the attachment leg of the electromagnet is machined at just one of its ends to create a tilting air gap between the attachment edge of the armature palette and the attachment leg of the electromagnet.

Advantageously, the electromagnet armature palette is not machined, and this means that standard armature palettes can be used with machined electromagnets in one and the same valve actuator.

For preference, the attachment leg of the electromagnet is in the form of a rectangular block having a step-shaped cutout that forms the tilting air gap.

According to another embodiment of the invention, a tilting edge of the armature palette, perpendicular to the attachment edge of the armature palette, is machined to create a tilting air gap between the attachment edge of the armature palette and the attachment leg of the electromagnet.

Advantageously, the electromagnetic is not machined, and this means that standard electromagnets can be used with a machined armature palette in one and the same valve actuator.

For preference, the armature palette is in the form of a block having two attachment edges and two tilting edges which are perpendicular to said attachment edges, the thicknesses of the tilting edges being different.

Advantageously, the two tilting edges of the armature palette allow magnetic attachment to standard closing and opening armature palettes.

For presence, the difference in thickness between the tilting edges of the armature palette ranges between 0.1 and 0.5 mm.

The invention also relates to a valve actuator comprising a set containing a first electromagnet and an electromagnet armature palette as claimed in one of the preceding claims, together with a second electromagnet, said attachment edge of the armature palette being designed to attach magnetically to two attachment legs formed respectively in the first and second electromagnets.

For preference, the attachment between the attachment edge and the attachment leg of the second electromagnet is asymmetric so as to encourage the armature palette to tilt in a predetermined direction when the magnetic attachment between the armature palette and the second electromagnet is broken.

Such a valve actuator advantageously allows the armature palette to be forced to tilt both on opening and on closing, the tilting of the armature palette being controlled and the actuator control laws improved.

Again for preference, the first and second electromagnets respectively comprise a first and a second tilting air gap, the first tilting air gap being positioned in line with the second tilting air gap.

Such a valve actuator advantageously allows the armature palette to be forced to tilt about the same tilting edge of the armature palette.

The invention will be better understood with the aid of the attached drawing in which:

FIG. 1 depicts a cross section through a valve actuator according to the prior art;

FIG. 2 depicts a perspective view of a closing electromagnet of the valve actuator of FIG. 1;

FIG. 3 schematically depicts the tilting of the armature palette about its stem as it detaches from the electromagnet of FIG. 2;

FIG. 4 is a view from above of an armature palette of a valve actuator according to a second prior art;

FIG. 5 depicts a perspective view of a closing electromagnet according to a first embodiment of the invention;

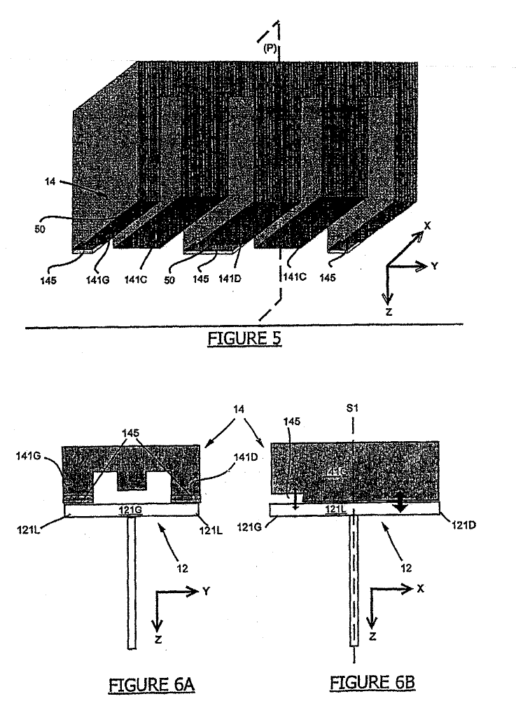

FIGS. 6A and 6B respectively depict and end-on view and a side view of part of the electromagnet of FIG. 5, attached to an electromagnet armature palette;

FIG. 7 depicts a perspective view of an electromagnet armature palette according to a second embodiment of the invention,

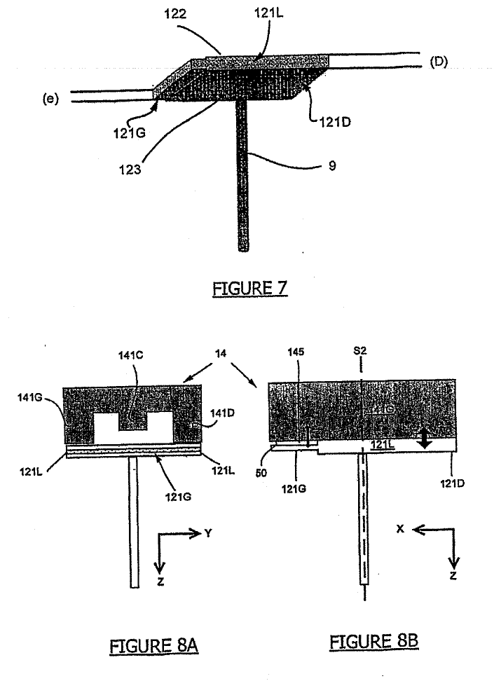

FIG. 8A and 8B respectively depict an end-on view and a side view of the armature palette of FIG. 7, attached to an electromagnet.

With reference to FIG. 5, a closing electromagnet 14 comprises five legs 141G, 141C, 141D, separated by four internal spaces and extending along a vertical axis Z. The electromagnet 14 here is designed to simultaneously control two electromagnet armature palettes 12 placed respectively one on each of the two sides of the plane of symmetry (P) of the electromagnet 14.

For the sake of clarity, the electromagnet 14 is depicted only partially in figures GA, 6B, 7A and 7B so that its interaction with just one armature palette 12 can be described precisely.

With reference to FIG. 6A, the electromagnet 14 comprises, in succession, in the direction of a directed axis Y, a first left-hand attachment leg 141G, a central leg 141C and a second, right-hand, attachment leg 141D. Each attachment leg 141G, 141D comprises a face 50 for contact with the armature palette 12, this face 50 having two longitudinal edges running in the direction X and two lateral edges running in the direction Y. The electromagnet 14 also comprises an internal magnet circuit, formed in part of magnets and designed to attract the armature palette 12 of a valve actuator magnetically at the end of its travel, as it moves.

The armature palette 12 is in the form of a block, the length of which extends along the axis X and the width of which extends along the axis Y, having two lateral edges 141L and two longitudinal edges 121G, 121D, the longitudinal edges 121G, 121D being known hereinafter as tilting edges.

As depicted in FIGS. 6A and 6B, the attachment legs 141G, 141D of the electromagnet 14 are respectively magnetically attached to the tilting edges 121G, 121D of the armature palette 12 when the electromagnet 14 is magnetically activated the latter, the armature palette 12 and the electromagnet 14 then being in contact along the contact face 50 of the legs 141G, 141D.

### First Embodiment

According to a first embodiment of the invention, with reference to FIGS. 5, 6A and 6B, one lateral edge of the contact face 50 of the attachment leg 141G is machined here to create a tilting air gap 145 between the armature palette 12 and the electromagnet 14.

With more particular reference to FIG. 6B, the attachment between the attachment leg 141G of the electromagnet 14 and the tilting edge 121G of the armature palette 12 is asymmetric in the plane (X,Z) with respect to a mid-plane parallel to the plane (Y,Z). With reference to FIG. 6B, in the plane (X,Z), the attachment between the armature palette 12 and the electromagnet 14 is asymmetric with respect to an axis S1 because of the presence of the air gap 145.

The asymmetry is assessed in a plane running substantially along the length of the contact face 50 of the attachment leg 141G, in this instance the plane (X,Z), the asymmetry being assessed in relation to a mid-plane of said leg, in this instance the plane (Y,Z). With reference to FIG. 6B, in the plane (X,Z), the attachment between the armature palette 12 and the electromagnet 14 is asymmetric with respect to an axis S2 because of the presence of the air gap 145.

As depicted in FIG. 5, the contact faces 50 of the attachment legs 141G, 141D are each machined to create a “step-shaped” cutout to create the air gap 145.

In order to provide an even better understanding of this embodiment of the invention, the interactions between the armature palette 12 and the electromagnet 14 will now be described.

When the closing electromagnet 14 is activated, the armature palette 12 is moved by the spring 20 and magnetically attracted into contact with the faces 50 of the legs 141G, 141D of the electromagnet 14. With reference to FIG. 6B, the attachment between the electromagnet 14 and the armature palette 12 is not symmetric, the tilting air gap 145 being created on the lateral edge of the attachment leg 141G of the electromagnet 14, the lateral edge being intended to attach itself magnetically to the tilting edge 121G of the armature palette 12.

As depicted in FIG. 6B, the magnetic interactions between the tilting edge 121G of the armature palette and the electromagnet 14, which interactions are represented in the form of arrows, are stronger than the interactions between the tilting edge 121D of the armature palette 12 and the electromagnet 14 because of the presence of the air gap 145.

When the closing electromagnet 14 is deactivated, the magnetic force of attraction of the armature palette 12 exerted by the electromagnet 14 diminishes gradually, the armature palette 12 detaching itself more quickly at its tilting edge 121G than at its opposite tilting edge 121D.

Thus, as the armature palette 12 detaches itself from the electromagnet 14, the armature palette 12 always tilts in the direction of its tilting edge 121G. The tilting is predictable and repeatable, which means that it can be anticipated. This tilting, which was previously considered to be a disadvantage because of its random nature, now allows precise valve control laws to be implemented. Such control laws perform better and allow the full benefit to be derived from the ability to control the valves individually.

It goes without saying that other kinds of machining of the electromagnet 14 could also be suitable for forcing the armature palette 12 to tilt in a given direction. Thus, drillings or counter bores produced in a contact face 50 of the attachment legs of the electromagnet 14 would also suit.

It goes without saying that an opening electromagnet, not depicted, may also comprise such tilting air gaps analogous to those of the closing electromagnet. In one particular embodiment of a valve actuator comprising opening and closing electromagnets, the air gaps of the opening electromagnet are positioned in line with the closing electromagnet so that the armature palette 12 always tilts along the same tilting edge.

### Second Embodiment

According to a second embodiment of the invention, with reference to FIGS. 7, 8A and 8B, the tilting edge 121G of the armature palette 12 is in this instance machined on its upper face 122 to create a tilting air gap 145 between the armature palette 12 and the electromagnet 14.

With more particular reference to FIG. 8B, the attachment between the attachment leg 141G, of the electromagnet 14 and the tilting edge 121G of the armature palette 12 is asymmetric in the plane (X,Z) with respect to mid-plane parallel to the plane (Y,Z).

The asymmetry is assessed in a plane running substantially along the contact face 50 of the attachment leg 141G, in this instance the plane (X,Z), the asymmetry being assessed in relation to a mid-plane of said leg, in this instance the plane (Y,Z).

As depicted in FIGS. 7 and 8B, the tilting edge 121G of the armature palette 12 is machined to create a “step-shaped” cutout to form the tilting air gap 145.

In order to provide a better understanding of this second embodiment of the invention, the interactions between the armature palette 12 and the electromagnet 14 will now be described.

When the closing electromagnet 14 is activated, the armature palette 12 is moved by the spring 20 and magnetically attracted to the faces 50 of the legs 141G, 141D of the electromagnet 14. As depicted in FIG. 8B, the magnetic interactions between the tilting edge 121G of the armature palette 12 and the electromagnet 14, which interactions are represented in the form of arrows, are stronger than the interactions between the tilting edge 121D of the armature palette 12 and the electromagnet 14, because of the presence of the air gap 145.

When the closing electromagnet 14 is deactivated, the magnetic force of attraction of the armature palette 12 exerted by the electromagnet 14 diminishes gradually, the armature palette 12 detaching itself more rapidly at its tilting edge 121G, in which the air gap 145 is formed, than at its opposite tilting edge 141D.

Thus, as the armature palette 12 detaches itself from the electromagnet 14, the armature palette 12 tilts in the direction of its tilting edge 121G. The tilting is predictable and repeatable, which means that it can be anticipated, or even compensated. This tilting, which was previously considered to be a disadvantage because of its random nature, allows the way in which the armature palette 12 is going to behave to be predicted, thus making it possible to implement precise valve control laws. Such control laws perform better and allow the full benefit to be derived from the ability to control the valves individually.

It goes without saying that other forms of machining of the armature palette 12 may also be suitable for forcing the armature palette 12 to tilt in the given direction. Thus, drillings or counter bores would also suit.

With reference to FIG. 7, the tilting edge 121G of the armature palette 12 is machined on each of its upper 122 and lower 123 faces, the thickness (e) of the tilting edge 121G of the armature palette 12 being less than the thickness (D) of its opposite edge, the difference in thickness between the two tilting edges 121G, 121D being of the order of one tenth of a millimeter. For a valve actuator, such an armature palette 12, machined on both its faces 122, 123, allows the armature palette to be forced to tilt with a closing electromagnet and also with an opening electromagnet.

The invention has been described here in relation to an armature palette that detaches itself from a closing electromagnet. It goes without saying that the invention also applies to an armature palette that attaches itself to/detaches itself from an opening/closing electromagnet.

1. A set comprising:
an electromagnet; and
an electromagnet armature palette that attaches magnetically to said electromagnet, wherein the armature palette comprises an attachment edge for attaching to an attachment leg formed in the electromagnet,
wherein the attachment between said attachment edge of the armature palette and said attachment leg of the electromagnet is asymmetric to encourage the armature palette to tilt in a predetermined direction when the magnetic attachment is broken.

2. The set as claimed in claim 1, in which the attachment leg of the electromagnet is machined at only one of its ends to create a tilting air gap between the attachment edge of the armature palette and the attachment leg.

3. The set as claimed in claim 2, in which the attachment leg is in the form of a rectangular block having a step-shaped cutout that forms the tilting air gap.

4. The set as claimed in claim 1, in which a tilting edge of the armature palette perpendicular to the attachment edge of the armature palette, is machined to create a tilting air gap between the attachment edge and the attachment leg.

5. The set as claimed in claim 4, in which the armature palette is in the form of a block having two attachment edges and two tilting edges which are perpendicular to said attachment edges, wherein the thicknesses of each of the tilting edges being is different.

6. The set as claimed in claim 5, in which the difference in thickness between each of the tilting edges of the armature palette ranges between 0.1 and 0.5 mm.

7. A valve actuator comprising:
a set comprising:
a first electromagnet;
an electromagnet armature palette comprising an attachment edge; and
a second electromagnet,
wherein said attachment edge of the armature palette being designed to attaches magnetically to two attachment legs formed respectively in the first and second electromagnets.

8. The actuator as claimed in claim 7, in which the attachment between the attachment edge and the attachment leg of the second electromagnet is asymmetric so as to encourage the armature palette to tilt in a predetermined direction when the magnetic attachment between the armature palette and the second electromagnet is broken.

9. The actuator as claimed in claim 7, in which the first and second electromagnets respectively comprise a first and a second tilting air gap, wherein the first tilting air gap positioned in line with the second tilting air gap.
